(19) United States
(12) Patent Application Publication
(10) Pub. No.: US 2009/0289094 A1
(43) Pub. Date: Nov. 26, 2009

(54) Hand-held electrically driven drive-in tool

(75) Inventors: Ulrich Schiestl, Feldkirch (AT); Robert Spasov, Schaan (LI); Karl Franz, Feldkirch (AT); Harald Fielitz, Buchs (CH)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/387,585

(22) Filed: May 4, 2009

(30) Foreign Application Priority Data
May 26, 2008 (DE) 10 2008 001 969.0

(51) Int. Cl. B25C 1/06

(52) U.S. Cl. 227/8; 227/132

(57) ABSTRACT

A hand-held electrically driven drive-in tool for driving fastening elements in a workpiece, includes a drive-in ram (13) displaceable in a guide (12) located in the tool housing (11) and driven by a the drive unit (30), a muzzle part (16) having a bolt guide (17) defining an axis (A) for a fastening element (60) and having a first guide section (117) and a second guide section (217) axially displaceable along the axis (A) relative to the first guide section (117) and disengageable from the first guide section (117), and a press-on switch (29) for generating a press-on signal.

### BACKGROUND OF THE INVENTION

1. Field of the Invention

The present invention relates to a hand-held electrically driven drive-in tool for driving fastening elements in a workpiece and including a guide located in the tool housing, a drive-in ram displaceable in the guide for driving a fastening element in the workpiece, a drive-in unit for driving the drive-in ram, a muzzle part having a bolt guide for a fastening element and defining an axis, and a press-on switch for detecting the contact of a mouth of the muzzle part with the workpiece.

2. Description of the Prior Art

A drive-in tool of the type described above is disclosed in German Publication DE 40 13 022 A1. In the known drive-in tool, a spring drives an impact mechanism for driving a nail toward the mouth of the muzzle part. For guiding the nail, a guide channel is provided in the muzzle part. An adjusting device for returning the impact mechanism in the initial position includes an electric motor and gear transmission mechanism therefor. The rotation of the electric motor is transmitted via the gear transmission mechanism and a cooperating with it, toothed disc to the hammer body of the impact mechanism in order to displace the impact mechanism against a biasing force of the drive spring in the initial position of the impact mechanism in which the impact mechanism is ready for a further impact process.

The drive-in tool of DE 40 13 022 A1 is designed for driving fastening elements in wood for which only a low setting energy of about from 10 J to 20 J is needed. When such a tool is designed for driving fastening elements in very hard constructional components or workpieces and is dimensioned, e.g., for driving fastening elements in steel or concrete (with setting energies about 80 J), then, the setting quality is not high because of an increased rebound of the drive-in tool that is lifted off the constructional component or the workpiece as a result of a rebound pulse during setting of the fastening element.

Accordingly, an object of the present invention is to provide a drive-in tool of the type described above and which enables it to achieve a high setting quality even in high-energy applications.

### SUMMARY OF THE INVENTION

This and other objects of the present invention, which will become apparent hereinafter, are achieved by providing, in a drive-in tool of the type discussed above a bold guide having a first guide section and a second guide section axially displaceable along the axis relative to the first guide section and disengageable from the first guide section.

During a drive-in process, the second guide section remains in abutment relationship with the workpiece during recoil of the drive-in tool due to its inertia and a complete disengagement from the first guide section and, therefore, from the drive-in tool. This enables an optimal guidance of the driven-in fastening element to the end of the drive-in process. Thereby, the setting quality remains high even at a high drive-in energy.

In a simplified embodiment of the invention, the first guide section is formed integrally with the muzzle part which has a receptacle in which the second guide section is displaceably supported.

Advantageously, the second guide section has a stop engageable with a counter-stop provided on the first guide section. Thereby, the two guide sections form a through guide channel when the drive-in tool is pressed against the workpiece, and the second guide section is displaced until its abuts the first guide section.

It is further advantageous when the second guide section includes a driver that cooperates, in a press-on state of the muzzle part against the workpiece, with a press-on probe for actuating a press-on switch. As a result, the press-on probe need not be displaced toward the mouth of the muzzle part, which permits to form the muzzle part mouth smaller.

Advantageously, the second guide section is spring-biased in a direction of a position of the second guide section in which the second guide section is decoupled from the first guide section. This prevents an uncontrolled actuation of the press-on switch.

In constructively convenient embodiment of the present invention, the driver is formed as a projection extending radially from the second guide section and extending through a slot formed in the muzzle part, with the slot length corresponding to a maximal withdrawal length of the second guide section from the receptacle of the muzzle part.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a longitudinal cross-sectional of a drive-in tool according to the present invention in the initial position of the tool; and

FIG. 2 a longitudinal cross-sectional view of the tool shown in FIG. 1 in a position in which the tool is pressed against a workpiece; and

FIG. 3 a longitudinal cross-sectional view of the tool shown in FIG. 1 after actuation of a setting process.

### DETAILED DESCRIPTION OF THE PREFERRED EMBODIMENT

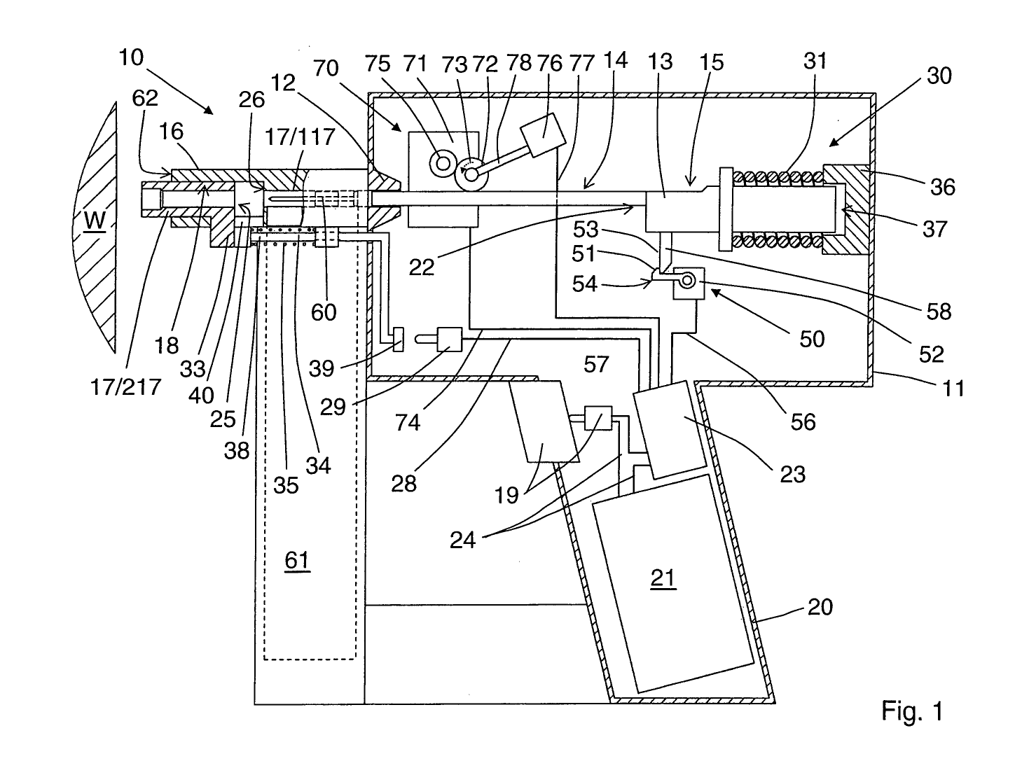

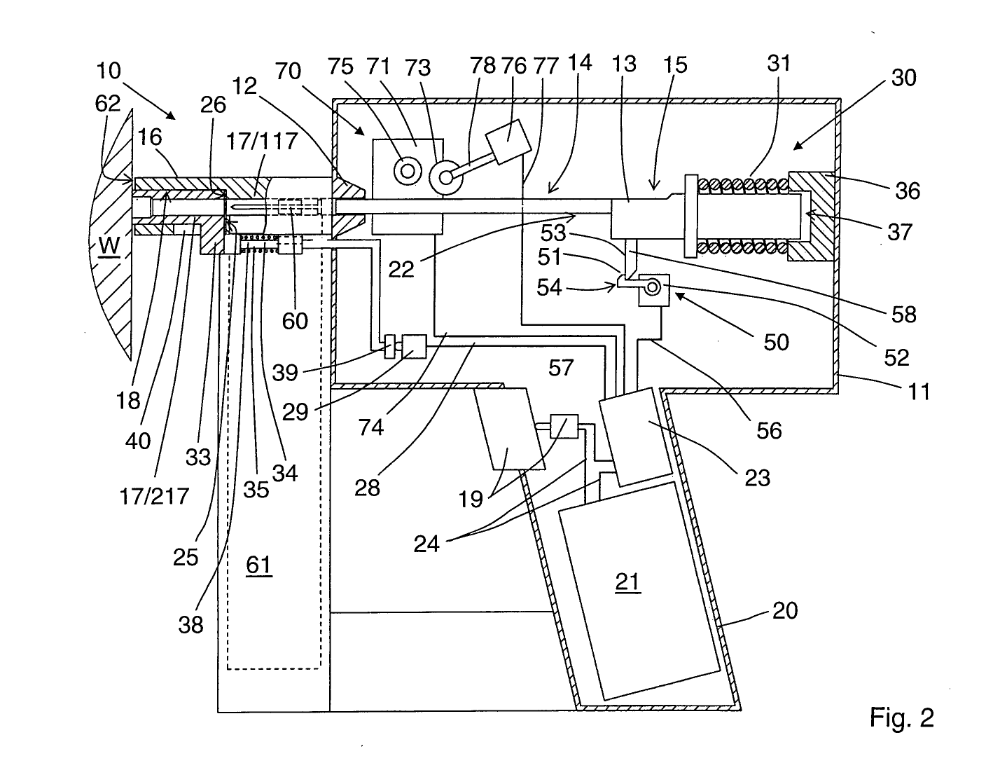

A drive-in tool 10 according to the present invention, which is shown in FIGS. 1-2, has a housing 11 and a drive unit which is generally designated with a reference numeral 30 and is located in the housing 11. The drive unit 30 is designed for displacing a drive-in ram 13 in a guide 12. The drive-in ram 13 has a drive-in section 14 for a fastening element 60 and a head section 15.

A muzzle part 16 adjoins an end of the guide 12 facing in a drive-in direction 27 and is provided with a bolt guide 17 extending coaxially with the guide 12. A magazine 61, in which fastening elements 60 are stored, projects sidewise of the muzzle part 16. The bolt guide 17 defines an axis A and has a first guide section 117 and a second guide section 217. The second guide section 217 can disengage from the first guide section 117 and is displaceable from the first guide section 117 along the axis A in the drive-in direction 27. The first guide section 117 is formed integrally with the muzzle part 16.

The second guide section 217 is formed as a guide sleeve that is axially displaceably arranged in a cylindrical receptacle 18 formed in the muzzle part 16.

The muzzle part 16 is provided, in the region of the receptacle 18, with an axially extending elongate breakout or slot 40 that adjoins the first guide section 117. A driver 33, which extends radially spaced from the second guide section 217, extends through the breakout or slot 40. The driver 33 cooperates, in the position of the drive-in tool 10 in which the muzzle part 16 is pressed against a workpiece W (see FIG. 2), with a press-on probe 34 for actuating a press-on switch 29. The second guide section 217 is elastically biased by a spring 35 to its position in which the guide section 217 is disengaged from the first guide section 117. The spring 35 is formed as a helical spring displaceable over a bar-shaped first end 38 of press-on probe 34 and supported against the muzzle part 16 or its projection with one of its end and against the driver 33 with another of its end. The second end 39 of the press-on probe 34 is spaced in a non-press-on state of the drive-in tool shown in FIG. 1, from the press-on switch 29.

The second drive section 217 has, in addition to the driver 33, a stop 25 engaging a counter-stop 26 provided on the first guide section 117, when the drive-in tool 10 is pressed, as shown in FIG. 2, against the workpiece W. The two guide sections 117, 217 form, in this state, a through guide channel for a to-be-set fastening element 60 and for the end of the drive-in ram 13 or its drive-in section 14.

In the embodiment shown in the drawings, the drive unit 30 has a drive spring 31 that serves as a force storing element and is supported with one of its ends against a support element 36 supported against the housing 11, and with another of its ends against the head section 15 of the drive-in ram 13.

In the initial position 22 of the drive-in ram 13, which is shown in FIG. 1, the drive-in ram 13 is resiliently preloaded against the drive spring 31 and has the free end of its head section 15 inserted in a cylindrical guide space 37 defined by the drive spring 31 and the support element 36.

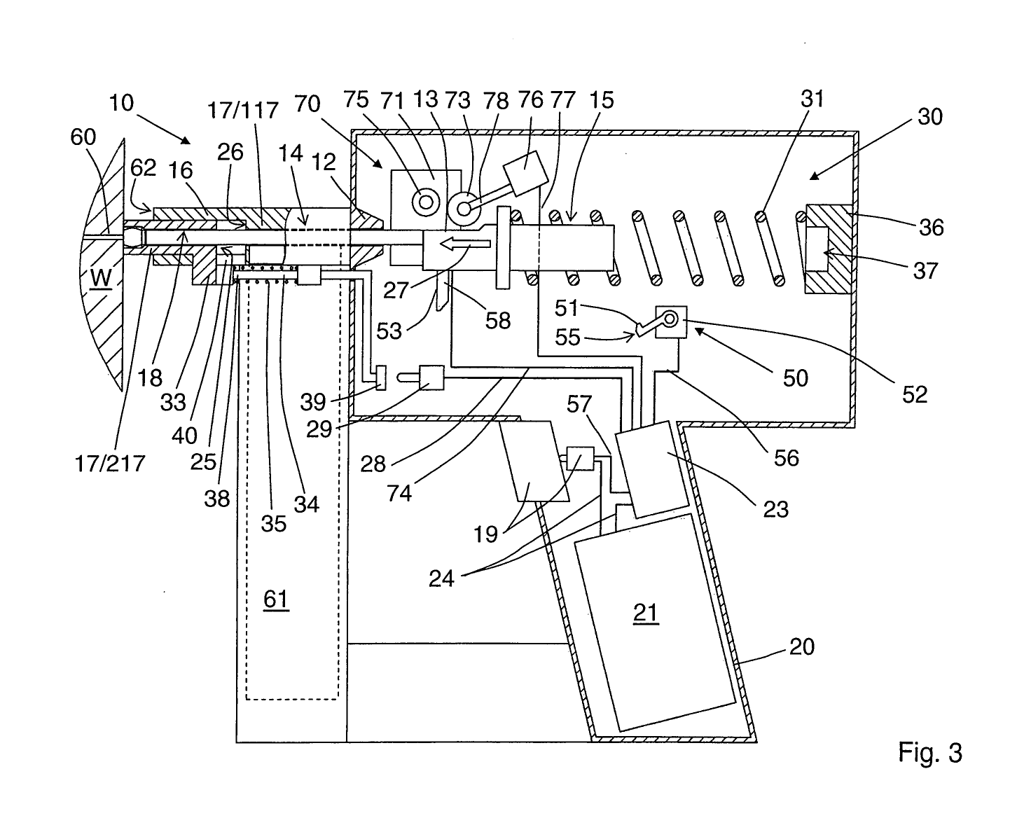

The drive-in ram 35 is held in its initial position 22 by a locking device generally designated with a reference numeral 50. The locking device 50 has a pawl 51 that engages, in a locking position 54 of the locking device 50 (see FIG. 1) a locking surface 53 on a projection 58 of the drive-in ram 13, retaining the drive in ram 13 against the biasing force of the spring 31. The pawl 51 is supported on a servo motor 52 that displaces it in a release position 55 shown in FIG. 3, as it would be explained further below. A first electrical conductor 56 connects the servo motor 52 with a control unit 23.

The drive-in tool 10 further has a handle 20 on which an actuation switch 19 for actuating a drive-in process with the drive-in tool 10 is arranged. A power supply, which is generally designated with a reference numeral 21 and which supplies the drive-in tool 10 with an electrical energy, is also located in the handle 28. Generally, the power source 21 has at least one accumulator. Electrical feeding conductors 24 connect the power source 21 with the control unit 23 and the actuation switch 19. The control unit 23 is connected with the actuation switch 19 by a switching conductor 57. The already mentioned press-on switch 29 is electrically connected with the control unit 23 by a conductor 28. The press-on switch 29 sends an electrical signal to the control unit 23 as soon as the drive-in tool 10 is pressed against a workpiece W, as shown in FIG. 2, insuring that the drive-in tool 10 can only then be actuated when it is properly pressed against the workpiece W.

On the drive-in tool 10, there is further provided a tensioning device generally designated with a reference numeral 70. The tensioning device 70 has a motor 71 that drives a drive roller 72. A second control conductor 74 electrically connects the motor 71 with the control unit 23 that actuates the motor 71, e.g., when the drive-in ram 13 is located in its end, in the drive-in direction 27, position or when the drive-in tool 10 is lifted off the workpiece W. The motor 71 has an output element 75 such as a driven wheel connectable with the drive roller 72. To this end, the drive roller 72 is rotatably supported on a longitudinally adjustable adjusting arm 78 of an adjusting device 76 formed as solenoid. A servo conductor 77 connects the adjusting device 76 with the control unit 23. During an operation, the drive roller 72 rotates in a direction shown with dash arrow 73.

When the drive-in tool 10 is actuated by a main switch, not shown, the control unit 23 insures firstly that the drive-in ram 13 is in its initial position 22 shown in FIG. 1. If this is not the case, then the drive roller 72 is displaced by the adjusting device 76 toward the output element 75 already set in rotation by the motor 71, engaging the same. Simultaneously, the drive roller 72, which rotates in a direction shown with arrow 73, engages the drive-in ram 13, displacing the drive-in ram 13, in the direction of the drive device 30. As a result, the drive spring 31 of the drive device 30 becomes preloaded. As soon as the drive-in ram 30 reaches its initial position 22, the pawl 51 of the locking device 50 engages the locking surface 53 of the projection 58 of the drive-in ram 13, retaining the drive-in ram in its initial position 22. Then, the motor 71 is turned off by the control unit 23, and the adjusting device 76, which is also controlled by the control unit 23, displaces the drive roller 72 from its engagement position with the output element 75 and the drive-in ram 13 to its disengagement position (see FIG. 2).

When the drive-in tool 10 is pressed with its muzzle part 16 against the workpiece W, as shown in FIG. 2, firstly, the press-on switch 29 puts the control unit 23 in a setting-ready position. The second guide section 217 is displaced against the biasing force of the spring 35 until the stop 25 of the second guide section 217 abuts the counter-stop 26 on the first guide section 117. The driver 33 displaces the press-on probe 34 in the direction of the housing 11 so that the second end of the press-on probe 34 actuates the press-on switch 29.

When the actuation switch 19 is actuated by a user, the control unit 23 displaces the locking device 50 in its release position 55, whereby the servo motor 52 lifts the pawl 51 off the locking surface 53 of the drive-in ram 13. The pawl 51 can be spring-biased in the direction of the drive-in ram 13.

Upon the pawl 51 being displaced in its release position 55, the drive spring 31, of the drive unit 30 displace the drive-in ram 13 in the drive-in directions 27, whereby a fastening element 60 is driven in the workpiece W. Because of rebounds of the drive-in tool 10, the drive-in tool 10 is displaced away from the workpiece W in a direction opposite the drive-in direction 27. At that, the second guide section 217 disengages from the first guide section 117 that is displaced, together with the drive-in tool 10, in the direction opposite the drive-in direction 27. The second guide section 217 also disengages from the press-on switch 29, with the second end 39 of the press-on probe 34 being lifted off the press-on switch 29 or with the first end 38 of the press-on probe 34 being lifted off the driver 33. Thus, due to its inertia and as a result of being completely disengaged from the first guide section, the second guide section 217 remains engaged with the workpiece W, as shown in FIG. 3, insuring an optimal guidance of the driven-in fastening element 60 up to the end of the drive-in process.

For returning the drive-in ram 13 and loading the drive spring 31 at the end of a drive-in process, the tensioning device 70 is actuated by the control unit 23 when the drive-in tool 10 is lifted off the workpiece W. To this end, the press-on switch 29 generates an appropriate signal which is transmitted to the control unit 23. The tensioning device 70 displaces the drive-in ram 13 in the above-described manner against the drive spring 31 of the drive unit 30, preloading the drive spring 31 anew, until the pawl 51 again is displaced into its locking position 54 in which it engages the locking surface 53 of the drive-in ram 13.

Alternatively to the disclosed embodiment having a drive spring preloaded by an electric motor, according to the invention, the electrically driven drive-in tool can have a flywheel drive or a solenoid drive driven by an electric motor.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A hand-held electrically driven drive-in tool for driving fastening elements in a workpiece, comprising a housing (11); a guide (12) located in the housing (11); a drive-in ram (13) displaceable in the guide (12); a drive unit (30) for driving the drive-in ram (13); a muzzle part (16) having a bolt guide (17) defining an axis (A) for a fastening element (60) and having a first guide section (117) and a second guide section (217) axially displaceable along the axis (A) relative to the first guide section (117) and disengageable from the first guide section (117); and a press-on switch (29) for generating a press-on signal upon a mouth (62) of the muzzle part (16) abutting the workpiece (W).

2. A drive-in tool according to claim 1, wherein the first guide section (117) is formed integrally with the muzzle part (16), and wherein the muzzle part (16) has a receptacle (18) in which the second guide section (217) is displaceably supported.

3. A drive-in tool according to claim 1, wherein the second guide section (217) has a stop (25) engageable with a counter-stop (26) provided on the first guide section (117).

4. A drive-in tool according to claim 1, wherein the second guide section (217) includes a driver (33) that cooperates, in a press-on state of the muzzle part (16) against the workpiece (W), with a press-on probe (34) for actuating a press-on switch (29).

5. A drive-in tool according to claim 1, comprising a spring (35) for elastically biasing the second guide section (217) in a direction of a position of the second guide section in which the second guide section (217) is decoupled from the first guide section (117).

6. A drive-in tool according to claim 4, wherein the driver (33) is formed as a projection extending radially from the second guide section (217) and extending through a slot (63) formed in the muzzle part (16), and wherein the slot (63) has a length corresponding to a maximal withdrawal length of the second guide section (217) from the receptacle (18) of the muzzle part (16).
